(19) United States
(12) Patent Application Publication
(10) Pub. No.: US 2012/0050503 A1
(43) Pub. Date: Mar. 1, 2012

(54) Portable Personal Entertainment Video Viewing System

(76) Inventor: Clifford H. Kraft, Naperville, IL (US)

(21) Appl. No.: 13/051,265

(22) Filed: Mar. 18, 2011

Related U.S. Application Data
(63) Continuation of application No. 11/391,952, filed on Mar. 29, 2006, now abandoned.

(51) Int. Cl. H04N 13/04; H04N 5/64

(52) U.S. Cl. 348/53; 348/838; 348/E13.075; 348/E05.128

(57) ABSTRACT

A portable head-worn audio/video display system that allows a user to watch and hear an audio/video media presentation such as a movie in a private environment. The movie or other media presentation can be stored on a separate or integral storage unit. The device can take the form of a pair of goggles or other head-piece that contains LCD or other video screens as well as audio transducers so that sound can accompany the video. The storage device can store movies and/or songs as well as any other type of presentation and can play these movies and/or songs to the user through the device according to a program or menu. The device can optionally contain a heads-up display as well as a cellular telephone. The heads-up display can display incoming telephone information such as information as to who called or SMS messages. These images can be displayed superimposed on the video media being watched. The present invention can also display relaxing scenes to the user instead of media video while the user listens to stored music.

### BACKGROUND

1. Field of the Invention

The present invention relates generally to portable entertainment systems and more particularly to a portable personal entertainment video viewing system.

2. Description of the Prior Art

Portable entertainment systems consist generally of a source of stored sound or music or other media, a playing device and a presentation device. For example, it is known in the art to play CD recordings, CDROM and DVD movies and other media on portable laptop computers. Complete movies can be stored on DVD disks or on magnetic disks or even in solid-state memory devices. These movies can then be played on the display screens of portable computers or other portable players. Audio can be played through earphones that are connected by wire or connected wirelessly.

A current class of popular products are miniature hard disks or solid-state devices that contain compressed music that play songs through earphones. The most popular of these devices was introduced by Apple Computer, Inc. under the name of iPod (iPod is a registered trademark). Apple and others are now selling or promising to sell similar devices that also contain movies that can be viewed on miniature screens.

While such prior art devices are useful for playing audio, they are inferior for playing video such as movies. Many movie-watchers would like to watch their favorite movie on a larger screen or in a way that fills their field of view. This is especially true while they are traveling on trains or airplanes, or as passengers in cars. Laptops are heavy and annoying, and others sitting nearby can either eavesdrop on the movie being shown or actually watch the movie at the same time. It would be advantageous to have a personal video entertainment system that could provide audio/video feed of media presentations in a way that was private and filled the entire field of view, but was also portable. Media presentations can include movies, songs with video or pictures, music video, music with still photos and any other audio/video entertainment material.

### SUMMARY OF THE INVENTION

The present invention relates to a handheld, portable personal entertainment media presentation video viewing system that can include a source of video and audio, a full field of view display apparatus that fits on a user's head and a means of transmitting the video from a source to the display apparatus. A particular type of display apparatus can be a set of video goggles that can optionally allow switching from a see-through mode to a watch-video mode.

The handheld portable video media presentation system of the present invention can include a storage device storing media video information; a video display worn on a user's head and covering a user's eyes that presents video images to the user, and a means for transmitting a portion of the media video information from the storage device to the video display. The storage device can be integral in the viewing apparatus, or media presentations can be streamed to the device from a cellular telephone. In one embodiment, the video media presentation system can include a video display that is a goggle or pair of goggles. The means for transmitting the video information can be wireless transmission and receiving devices which can be Bluetooth or other types of wireless devices. In an embodiment, the video display can have a see-through mode that can be evoked by the user using a manual control or a face switch that responds to a face muscle movement. An embodiment can contain a cellular telephone coupled into the audio and/or video part of the invention. An embodiment can contain a heads-up display in the video display for overlaying menu information or cellular telephone information such as who-is-calling and/or SMS messages. In embodiments of the present invention that use storage devices, these devices can be hard drives, optical drives, solid-state memory or any other type of storage device. The media presentation system of the present invention can include ear transducers in proximity to the user's ears and a means for transmitting audio information from said storage device to said ear transducers such as wire or a further wireless channel.

### DESCRIPTION OF THE DRAWINGS

FIG. 1 shows a wireless embodiment of the system of the present invention using display goggles.

FIG. 2 shows a wired version of the embodiment of FIG. 1.

FIG. 3 shows a cross-section of the goggles of FIGS. 1-2.

FIG. 4 shows a block diagram of the functioning of an embodiment of the present invention.

FIG. 5 shows the goggles of FIG. 3 with an optional mode-change switch that can be hand or face controlled.

FIG. 6 shows a heads-up display superimposed on a video scene.

FIGS. 7A-&B show an embodiment of the present invention that also includes a cellular telephone.

FIG. 8 shows an embodiment of the present invention where the media storage is integrated with the head-piece.

FIG. 9 shows a cross-section of the embodiment of FIG. 8.

Several drawings and illustrations have been presented to aid in the understanding of the present invention. The scope of the present invention is not limited to the figures.

### DETAILED DESCRIPTION OF THE INVENTION

The present invention relates to a portable system for presenting video and audio to a user in a mode that is private and allows for a full field of view.

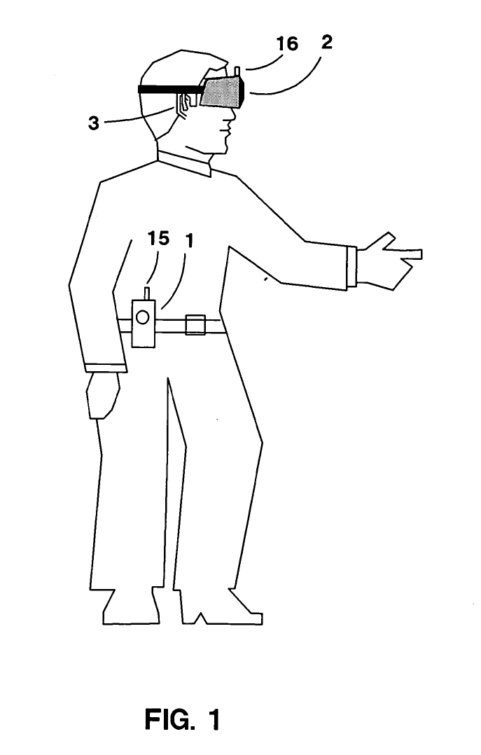

Turning to FIG. 1, an embodiment of the system of the present invention can be seen. A storage device or pod 1 can contain a miniature hard drive or solid state storage device, or any other type of storage device. The storage device can contain compressed multi-media such as video and audio. Commonly known types of compression include M-PEG, MP3, MP4 and others. The storage device 1 can also be a miniature DVD player with movies or other media stored on optical DVD devices. While these storage devices are known, the present invention can use any storage device that can store picture or video information.

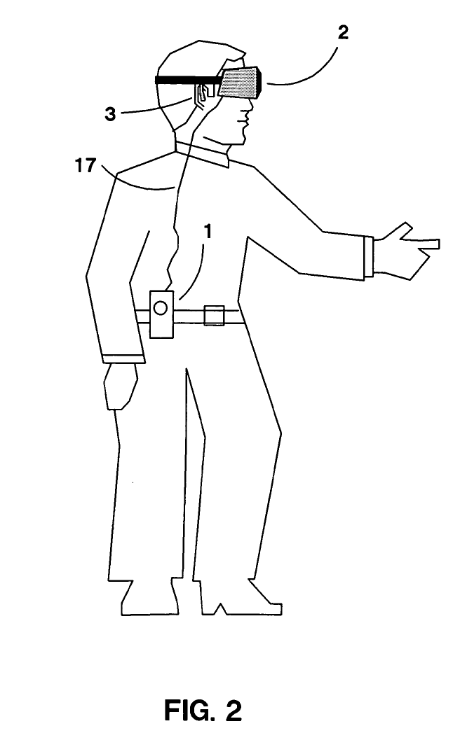

The storage device 1 in FIG. 1 normally transmits video and audio information to a display device 2. The transmission can be by wires (similar to headphone wires) or can be done wirelessly. FIG. 1 shows the device with an transmitting antenna 15 and a receiving antenna 16. A particular wireless method is known a Bluetooth which allows a data rate of 433.9 kbps in a 5-slot packet Faster rates up to 721 kbps can be achieved using an asymmetric channel. The new Bluetooth 2.0 standard allows wireless transmission for short distances of data rates up to 3 times that original Bluetooth rate. These rates are entirely sufficient for transmitting the compressed video/audio of a movie or other media presentation. Any transmission method or technique is within the scope of the present invention including direct wiring between the storage device 1 and the head-piece 2. A wired embodiment of the present invention is shown in FIG. 2. A standard earphone cable 17 can be used in a wired version. Audio can be played through an earphone or pair of earphones 3 attached to the head-piece or by any other audio means.

It is also not necessary that the storage device be separate from the display apparatus. In fact, in an alternate embodiment, the storage device can be made integral with the display apparatus. In another alternate embodiment, media data can be streamed to the user's unit via cellular telephone.

A preferred embodiment of the head-piece display apparatus in FIGS. 1-2 is a device that covers the eyes like a set of goggles 2. This apparatus contains display screens positioned and focused so that the eyes can see a play of continuous video. The user can where the goggles on the head and place the goggles 2 over the eyes with an optional set of ear transducers 3 placed near the ears (or optionally a set of earphones—wired or wireless) and then completely relax and watch a movie or any type of video or audio/video or multi-media presentation in complete privacy. This is excellent for train, bus and airplane travelers to pass the time, and to watch, for example, a movie of the traveler's choice. If a wireless link is used, the eye-piece device can contain an optional antenna 16.

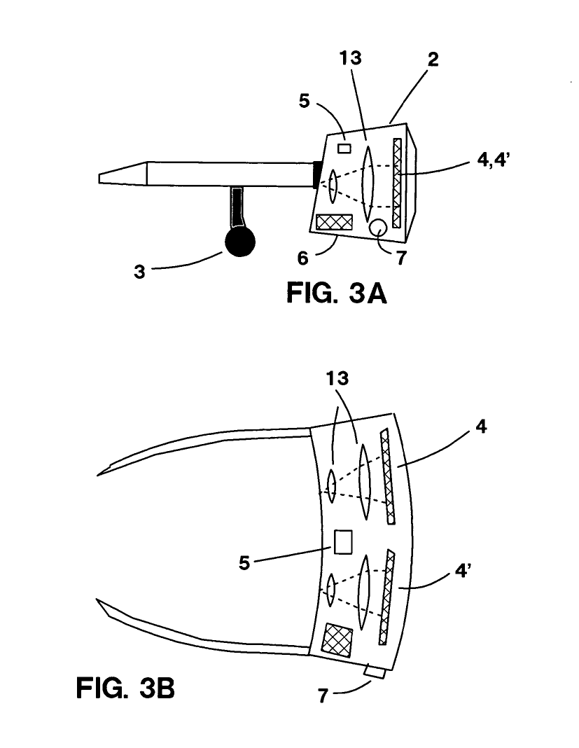

It is known in the optical and virtual reality arts to place a video image in a set of goggles 2 so that the image is in-focus and contains complete depth of field. In a optional mode, the image can also be made 3-dimensional. This type of presentation can be part of the compressed video that is supplied from the video source. FIGS. 3A-3B show a cross-section of a goggle embodiment of the display apparatus of the present invention. Video transducer screens 4 and 4′ are positioned so that a pair of images appear in normal depth of field context before the eyes when lens 13 are used to focus. Such screens 4, 4′ can be LCD devices or other video devices known in the art. A receiver 5 can receive video and audio information from a remote or integral media storage unit and sends this information to a processor 6 or other electronic device. The processor can perform any signal processing, including decoding and/or decompression, needed to present video to the screens 4, 4′ which can present a focused 2-dimensional or 3-dimensional image to the eyes through a system of lenses 13. In particular, the processor or hardwired device 6 which may also be an ASIC, can convert video or compressed video into signals suitable to drive the displays such as, for example, RGB or Y, Y-B, Y-R known in the art. FIGS. 3A-3B also show a transducer or pair of ear transducers 3 that can be used to present media audio to the ears. An optional embodiment of the present invention can use a set of standard wired or wireless earphones separate from the goggles or video presentation device.

The device shown in FIGS. 3A-3B also contain a set of controls 7 which can include video volume, brightness, program select, and other controls. If the storage device is separate such as that shown in FIG. 1, program select controls and menus can be placed on that device as well as on the head-piece (or they can reside entirely on the storage device).

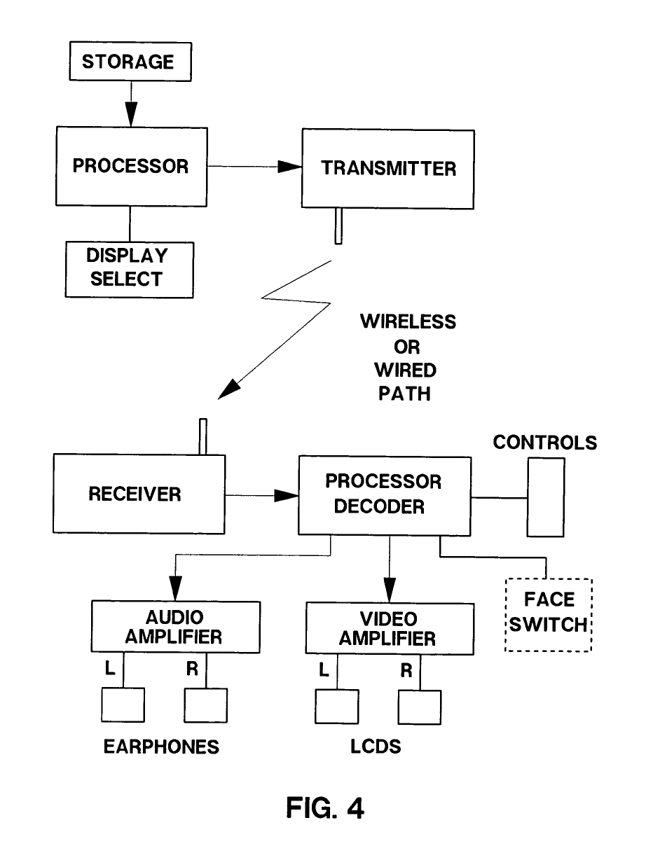

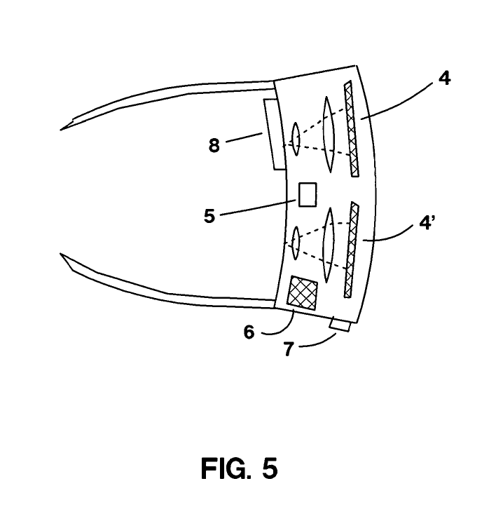

FIG. 4 shows a block diagram of an embodiment of the present invention. In the upper part of FIG. 4, a storage device is coupled to a processor. The storage device can store numerous media presentations such as movies, videos, music videos, songs, film clips and any other type of media presentation. The processor can be controlled by a select control group that can turn the device on and off, select presentations, edit what is stored and perform other user functions. The processor can pull up compressed presentations (say a movie), and transmit compressed video/audio to the eye display device (goggles). As previously stated, the transmission can be wired or wireless. In the lower part of FIG. 4, a receiver can be seen that receives the transmitted presentation. The compressed video/audio data can be sent to a processor-/decoder that can recover audio and video. The audio can be stereo or monaural, and the video can be 2-dimensional or 3-dimensional. The audio is normally amplified and supplied to earphones, while the video can be sent to a video driver or LCD that emits a light image that can be focused by lenses in order to see. The head-piece can optionally contain controls such as volume, brightness, contrast, color and any other type of control. The head-piece can also optionally contain a face or head switch (8 in FIG. 5) that can cause the goggles to enter a see-through mode so the user can see out. While FIG. 4 shows the decompression taking place at the head device, decompression (if compression is used) can also take place at the storage unit. In a different embodiment, the storage unit can be integrated with the head-piece.

As previously stated, the display apparatus can be made to allow a vision pass-through or see-through mode. Such a mode change is known in the optical arts and can be accomplished with mirrors, special screens, LCDs or by other means. The change of mode can be made with a manual switch or a face controlled switch. FIG. 5 shows the goggles of FIG. 1 or 2 with such a switch 8. This switch could change the goggles to see-through (by putting the video into a pause mode or by simply bypassing the video feed. The optional face-controlled or manual switch 8 could be controlled by a movement of the scalp or face muscles to provide instantaneous see-through or to change back to a video mode. The see-through or vision pass-through mode allows the user to immediately kill the video and resume normal vision out of the head-piece. This would be useful when the user wanted to look out, or in an emergency, when a quick switch to external vision was necessary.

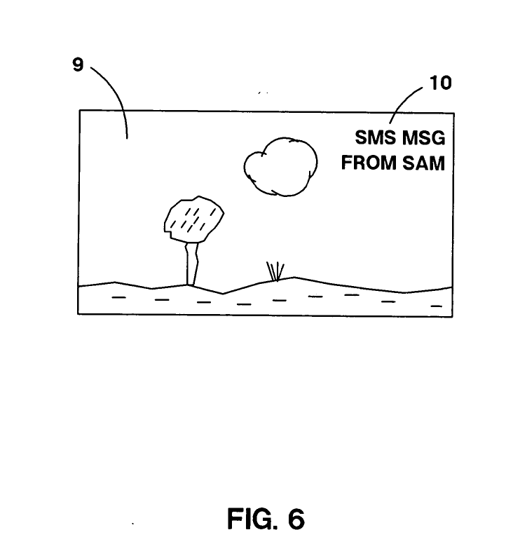

The goggles of FIGS. 1-3 can also be equipped with an optional heads-up display known in the art to display menu or other information over the video. This could be useful when the user wants to fast-forward, change programs, or for other purposes such as cellular telephone information as will be explained. FIG. 6 shows a heads-up display 10 superimposed on a movie scene 9. In this case, the user sees an indication of an SMS message arrival on top of the movie the user is currently watching. Any type of heads-up message could be displayed including media menus such as song or movie selections.

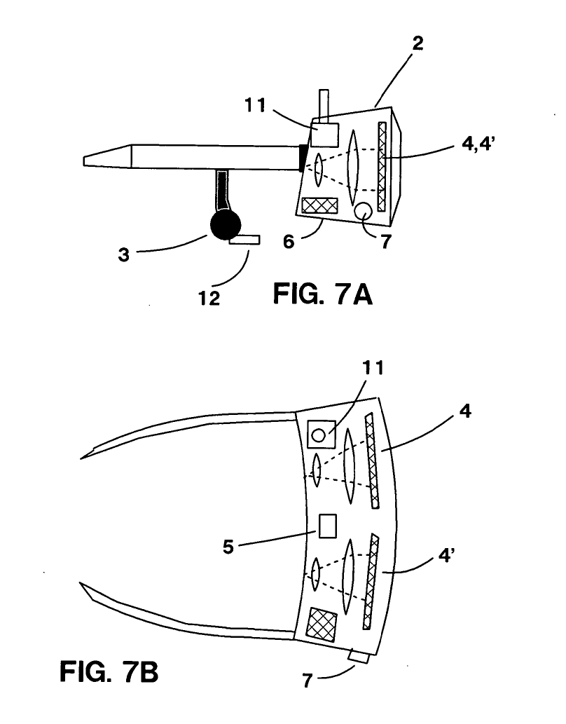

The display apparatus of the present invention can also be coupled to or contain an optional cellular telephone 11. FIGS. 7A-7B show an embodiment of the goggles from FIGS. 1-2 with a cellular telephone 11. A microphone 12 could be hidden in the goggles or in or near the ear transducer 3. The present invention can contain any other type of communications or radio device such as a walky-talky, scanner, amateur radio transceiver, pager or other device in addition or instead of a cellular telephone. Such a communications device like a cellular telephone could be used in conjunction with the heads-up display 10 previously described. An incoming telephone call, for example, could activate the heads-up display on top of a movie or media presentation being watched to announce who is calling. The user could then accept the call (optionally automatically pausing the video), or could reject it. The heads-up display 10 could also be used to display instant messages such as SMS or other messages over the video being played. In a preferred mode, this feature could be turned on or off by the user.

While not presently available, a portable video telephone may soon appear. Such a telephone could be used with the present invention, at least for receiving and displaying video telephone images in the display apparatus 1. The present invention can be used with current cellular telephones that transmit still pictures. Such pictures can be immediately displayed on the display apparatus 1, either alone or superimposed over an ongoing video media presentation.

An optional mode of operation of the present invention would be to play music through the audio transducers 3 while simultaneously displaying stored or computer-generated relaxing scenes on the screens 4, 4′ rather than media video. These relaxing scenes could be nature scenes or mathematically generated scenes (factals) as is known in the art.

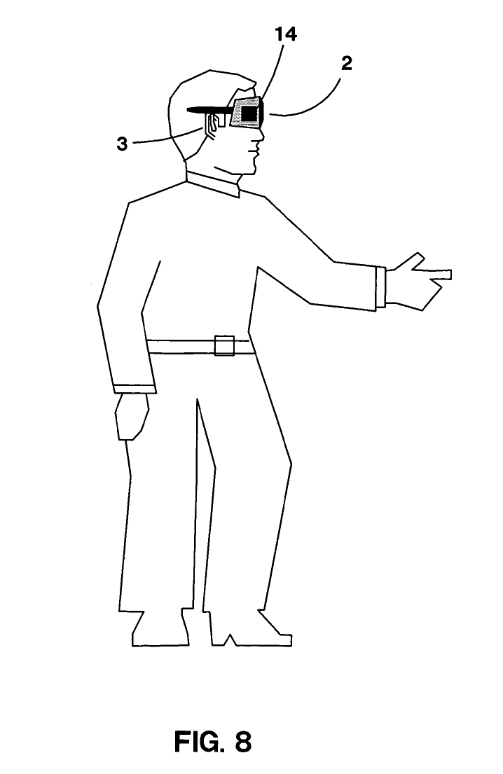

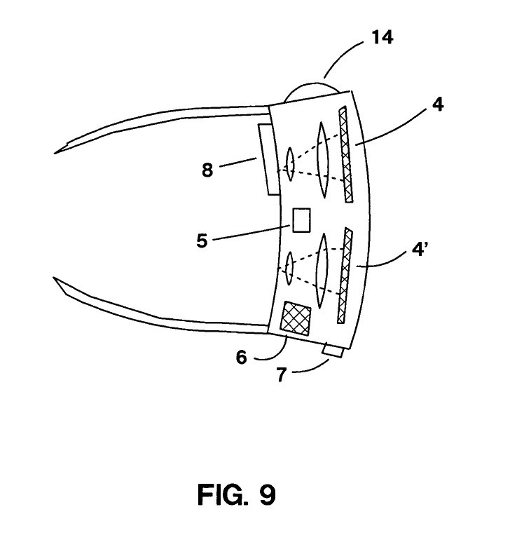

As previously stated, the media storage device can be made integral with the head-piece. FIG. 8 shows such an embodiment with a storage module 14 attached to the side of the goggles 2. The storage module could be placed anywhere on or in the head-piece in this embodiment. FIG. 9 shows the media storage module 14 on the side of the goggle.

Several descriptions and illustrations have been presented to aid in understanding the present invention. One skilled in the art will realize that numerous changes and variations are possible without departing from the sprit of the invention. Each of these changes and variations is within the scope of the present invention.

1. A portable system for playing a video presentation including:
a storage device and a cellular telephone, the storage device being operatively connected to the cellular telephone;
a head-worn display in communication with the storage device, said head-worn display covering the user's eyes and including a separate display screen for each eye and a pair of earphones in proximity to the users ears, wherein audio/video signals are transmitted from said storage device to said head-worn display for viewing and listening by said user; and
wherein the cellular telephone receives audio/video signals from a network and the storage device receives the signals from the cellular telephone.

2. The portable system of claim 1 wherein said display is in wireless communication with said storage device.

3. The portable system of claim 2 wherein said wireless communication is BLUETOOTH.

4. The portable system of claim 1 further comprising a heads-up display superimposed on at least one of said display screens.

5. The portable system of claim 4 wherein said heads-up display displays an SMS message.

6. The portable system of claim 1 further comprising a processor in said housing and a display mounted on said housing, wherein said processor causes said display to display a menu of video selections that can be viewed on said head-worn display.

7. The portable system of claim 1 wherein said storage device is a solid-state memory.

8. The portable system of claim 1 wherein said head-worn display has a see-through mode.

9. The portable system of claim 1 wherein call information from said cellular telephone can be displayed on said head-worn display.

10. The portable system of claim 1 wherein said housing contains a DVD player.

11. The portable system of claim 1 wherein said audio/video signals are transmitted over a cellular telephone network.

12. The portable system of claim 1 wherein said storage device is in said head-worn display.

13. The portable system of claim 1 further comprising a housing separate from said head-worn display, said housing containing said storage device.

14. The portable system of claim 1 further comprising a microphone in said head-worn display.

15. A method for viewing video over a network comprising:
receiving a video signal on a cellular telephone;
storing said video signal in a storage device;
transferring said video signal from said storage device to a head-worn display, said head-worn display including a separate display screen for each eye, wherein a first portion of said video signal is presented to a left display screen and a second portion of said video signal is presented to a right display screen.

16. The method of claim 15 further comprising receiving an audio signal along with said video signal on the cellular telephone and presenting said audio signal to stereophonic earphones in said head-worn display.

17. The method of claim 15 wherein said video signal can be stored in the storage device for later display.

18. A portable system for playing a video presentation including:
a storage device and a cellular telephone, the storage device being operatively connected to the cellular telephone;
a head-worn display in communication with the storage device said head-worn display covering the user's eyes and including a separate display screen for each eye wherein video signals are transmitted from said storage device to said head-worn display for viewing by said user; and
wherein the cellular telephone receives video signals from a network and the storage device receives the signals from the cellular telephone
